(19) United States
(12) Patent Application Publication
(10) Pub. No.: US 2009/0300691 A1
(43) Pub. Date: Dec. 3, 2009

(54) METHOD AND SYSTEM OF OPERATING CONTENT STREAMS

(75) Inventor: Benjamin J. Fletcher, Hampshire (GB)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/131,450

(22) Filed: Jun. 2, 2008

(51) Int. Cl. H04N 7/173

(52) U.S. Cl. 725/90

(57) ABSTRACT

A method and system of operating content streams. The method includes detecting that a playing of first and second content streams is asynchronous, each of the first and second content streams respectively including first and second turning points, and selectively synchronizing at least the first and second turning points of the first and second content streams by inserting gap fillers into at least one of the first and second content streams.

### BACKGROUND OF THE INVENTION

1. Field of the Invention

Aspects of the present invention are directed generally to multi-media applications and, more particularly, to a method and a system of operating content streams.

2. Description of the Background

As multi-media applications become more and more common in our society, it has become increasingly apparent that different individuals may be required to and/or desire to receive multi-media content at various rates. That is, some individuals may want to receive content slower so that they can absorb more of it while others may want to receive content faster to allow them to do other activities. Similarly, some individuals may have relatively slow content streaming tools and may not be able to receive content at high rates.

For example, first and second users are watching the same football game in a relatively close geographical area or a virtual world. The first user, Ben, wants to watch the football game at 80% of the real world pace, while the second user, Sam, want to watch the game at 120% of the real world pace. Concurrently, Ben and Sam still want interact with one another despite their differing viewing habits. Moreover, an additional individual, Alice does not want to watch the game but is present and also wants to interact with Ben and Sam.

As such, in this example, each of the three participants may be seen to exist in a virtual world that, unlike the real world, can have multiple parallel space-time dimensions. Here, it is apparent that times for each of the individuals are all different but that the space for Ben, Sam and Alice are the same in that they each have the football game in their respective points of view (POVs). Thus, when a score occurs in the football game, Sam may celebrate and ruin the experience for Ben. Alice may not care about the football game but may care about knowing whether the football game is synchronized for Ben and Sam.

### SUMMARY OF THE INVENTION

In accordance with an aspect of the invention, a method of operating content streams is provided and includes detecting that a playing of first and second content streams is asynchronous, each of the first and second content streams respectively including first and second turning points, and selectively synchronizing at least the first and second turning points of the first and second content streams by inserting gap fillers into at least one of the first and second content streams.

In accordance with another aspect of the invention, a method of operating content streams is provided and includes detecting that first and second content streams are asynchronously provided to first and second individuals, each of the first and second content streams respectively including first and second turning points, where at least one of the first and second individuals has an interest in the other, selectively synchronizing at least the first and second turning points of the first and second content streams by inserting gap fillers into at least one of the first and second content streams, and temporarily alerting at least the interested individual that the first and second turning points are synchronized.

In accordance with another aspect of the invention, a system configured to operate content streams is provided and includes a detecting unit configured to detect that first and second content streams are asynchronously provided to first and second individuals, each of the first and second content streams respectively including first and second turning points, a receiving unit configured to receive interest data indicating that at least one of the first and second individuals has an interest in the other, and a synchronizing unit configured to selectively synchronize at least the first and second turning points of the first and second content streams by inserting gap fillers into at least one of the first and second content streams.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTIONS OF THE DRAWINGS

The subject matter regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 is a schematic illustration of a virtual and/or real world environment in which a method of operating content streams according to an exemplary embodiment of the present invention is applied;

FIG. 2 is a flow diagram illustrating a method of operating content streams according to an exemplary embodiment of the present invention; and

FIG. 3 is a schematic diagram of a system configured to operate content streams according to an exemplary embodiment of the present invention.

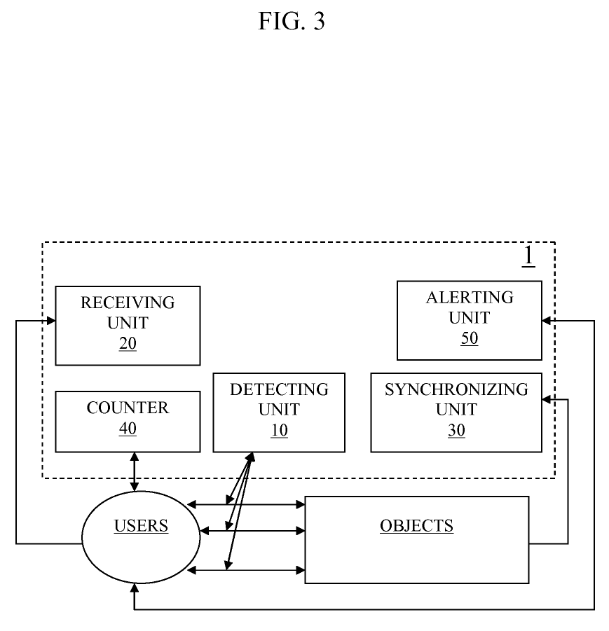

### DETAILED DESCRIPTION OF THE INVENTION

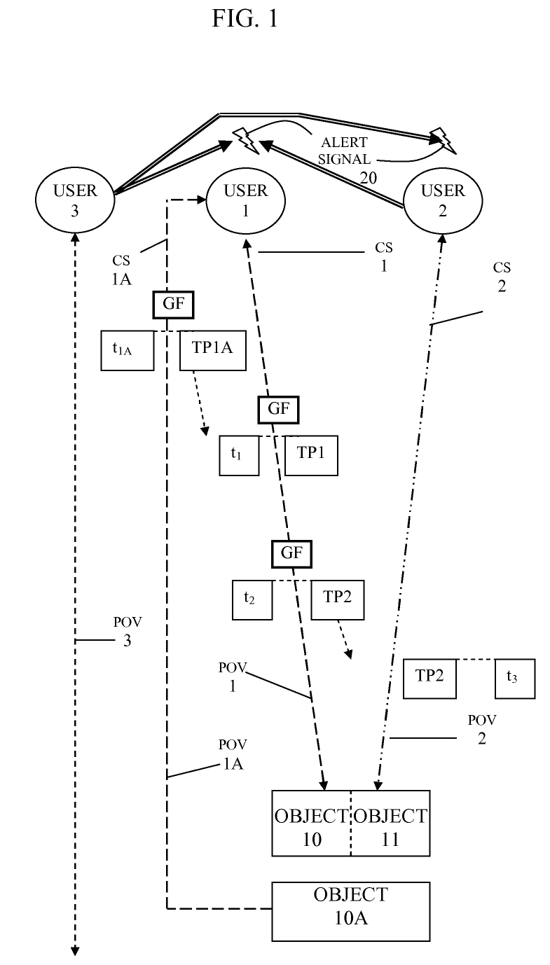

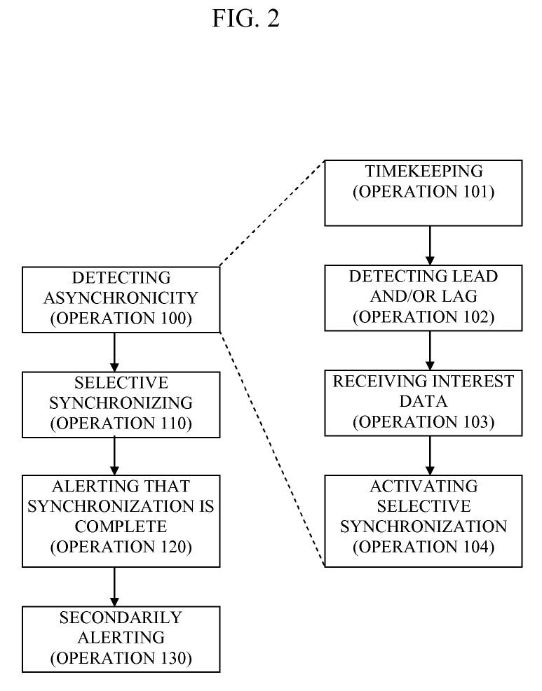

With reference to FIGS. 1 and 2, a method of operating content streams is provided and includes detecting that a playing of first and second content streams CS1 and CS1A or CS1 and CS2 is asynchronous (operation 100). Here, each of the first and second content streams CS1, CS1A and CS2 respectively includes first and second turning points TP1, TP1A and TP2. The method further includes selectively synchronizing at least the first and second turning points TP1 and TP1A or TP2 of the first and second content streams CS1 and CS1A or CS1 and CS2 (operation 110). This may be accomplished by, e.g., inserting gap fillers GF into at least one of the first and second content streams CS1 and CS1A or CS1 and CS2.

That is, an embodiment of the invention exists where the content streams are dissimilar. In this embodiment, user 1 watches the movie “The Wizard of Oz” on object 10 via POV 1 and listens to the soundtrack “The Dark Side of the Moon” on object 10A via POV 1A. Here, user 1 wishes to observe the synchronicity (which is assumed herein) of the two content streams CS1 and CS1A but fails to start them at the proper time with respect to each other for the synchronicity to take effect.

In this embodiment, the asynchronicity between the content streams CS1 and CS1A is detected in that, e.g., the soundtrack leads the movie by a given lead time (e.g., the period from t_{1A} to t₁). Accordingly, since the reason behind watching the movie and listening to the soundtrack together relies on their synchronicity, gap fillers GF are inserted in to the content stream of the soundtrack CS1A to delay the playing of the soundtrack by a length of time equal to the detected lead time. This provides a counterbalance to the lead of the soundtrack at least by the time of the first respective turning points TP1 and TP1A in the movie and the soundtrack, which will now occur substantially simultaneously and thereby provide entertainment for user 1.

Another embodiment exists where the content streams are similar. In this embodiment, user 1 and user 2 each watch the same football game as content streams CS1 and CS2 on object 10 via POV1 and object 11 via POV2, respectively. Further, user 1 and user 2 are known to be interested in observing each other's enjoyment and/or discussing the game in real time.

In this embodiment, it is detected that content stream CS1 leads content stream CS2 by a given lead time (e.g., the period from t₂ to t₃). Accordingly, since user 1 and user 2 are known to have an interest in one another, gap fillers GF are inserted into at least content stream CS1 so as to delay the playing of the football game by a length of time equal to the lead time. As before, this provides a counterbalance to the lead of the content stream CS1 at least by the time of the first respective turning points TP2 in both content streams, which will now occur substantially simultaneously such that user 1 and user 2 can interact with each other.

In accordance with at least these embodiments, the turning points TP1, TP1A and TP2 each include portions of the respective content streams CS1, CS1A and CS2 which are more relatively important than other portions of the content stream. That is, for user 1 watching the movie and listening to the soundtrack, the turning points TP1 and TP1A may be instances where the movie and the soundtrack are known to be particularly well timed to one another. Similarly, for user 1 and user 2 watching the football game, the turning points may be touchdowns or turnovers.

Further, it is understood that the gap fillers may include secondary content streams, such as advertisements, or some other form of a break in the content streams. The type and/or form of the gap fillers GF may be predetermined based on user preferences or may be variable based on a relationship to the content streams. For example, if the content stream into which the gap filler GF is inserted is a football game, the gap filler may be a commercial that is directed to a football fan, such as a beer or car commercial.

In further embodiments of the invention, user 1 and user 2 may be first and second individuals located within a respective space defined in the real world. Alternatively, they may each be represented by an avatar located within respective virtual worlds. In any case, timekeeping with respect to each of the first and second content streams and each of the first and second individuals is maintained (operation 101) so as to allow for the detection of the asynchronicity of the first and second content streams. That is, by way of the timekeeping of the space in each user occupies, it may be detected that one of the first and second content streams CS1 or CS2 leads and/or lags the other content stream (operation 102).

In still further embodiments, the detection of the asynchronicity of the first and second content streams may further include receiving interest data (operation 103). The interest data indicates that at least one of the first and second individuals has an interest in at least the other individual. Here, an interest on the part of one user for another may be manifested as a desire to discuss the respective content streams with the other user or to enjoy the respective content streams together following turning points therein.

The selective synchronization of operation 110 is, thus, activated based on the timekeeping data from which a lead and/or a lag may be detected in different content streams and based on the received interest data (operation 104). That is, the selective synchronization is only activated when a lead and/or a lag between different content streams exists and when one user has an interest in another user. In this way, the addition of gap fillers GFs into content streams where they are not needed is prevented.

In an additional embodiment of the invention, an alert signal 20 (see FIG. 1), with respect to a particular user, is provided to the other users who have an interest in the particular user when the content stream of the particular user is synchronized with the content streams of the other users (operation 120). That is, the content stream CS2 of user 2 may initially lead the content stream CS1 of user 1. Subsequently, the content stream CS2 has gap fillers GF inserted into it and, once user 2's content stream CS2 is synchronized with user 1's content stream CS1, user 2 is informed of that fact by the presence of the alert signal 20 in user 2's POV. This way, user 2 is confident that he can discuss the football game with user 1 without risking ruining any surprises for user 1.

In an additional embodiment, it is noted that the alert signal 20 may be removed once an asynchronicity between content streams is detected again. In this case, the removal of the alert signal 20 will continue until the asynchronous content stream can be re-synchronized (operation 130).

With reference to FIG. 1, it is noted that the alert signal 20 may be useful even where a user is not interested in a content stream in any way related to those of other users. As shown in FIG. 1, user 3 has POV3 which is not directed at any of the objects 10, 10A or 11. Thus, it may be seen that user 3 has no respective content stream and a time of the space that user 3 occupies is, therefore, always synchronized with respect to that of user 1 and user 2. As such, the alert signal 20 is always visible within user 3's POV.

In accordance with another aspect of the invention, the methods described above may be embodied as a computer readable medium having instructions stored thereon to execute the methods described above.

In accordance with further aspects of the invention, a system 1 may be configured to operate content streams. Here, the system 1 includes a detecting unit 10, which is configured to detect that first and second content streams are asynchronously provided to first and second individuals, with each of the first and second content streams respectively including first and second turning points. A receiving unit 20 is configured to receive interest data indicating that at least one of the first and second individuals has an interest in the other. A synchronizing unit 30 is configured to selectively synchronize at least the first and second turning points of the first and second content streams by inserting gap fillers into at least one of the first and second content streams.

A counter 40 is configured to keep a time of each of the first and second content streams and each of the first and second individuals. An alerting unit 50 is configured to temporarily alert at least the interested individual that the first and second turning points are synchronized. The alerting unit 50 is further configured to alert at least the one of the first and second individuals having the interest in at least the other individual that the first and second content streams are asynchronous.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

We claim:

1. A method of operating content streams, comprising:
detecting that a playing of first and second content streams is asynchronous, each of the first and second content streams respectively including first and second turning points; and
selectively synchronizing at least the first and second turning points of the first and second content streams by inserting gap fillers into at least one of the first and second content streams.

2. The method according to claim 1, wherein the turning points comprise portions of the content stream which are more relatively important than other portions of the content stream.

3. The method according to claim 1, wherein the gap fillers comprise secondary content streams, the playing of which delays the playing of the content stream into which the secondary content stream is inserted.

4. The method according to claim 1, wherein the gap fillers comprise breaks that delay the playing of the content stream into which the breaks are inserted.

5. The method according to claim 1, wherein the first and second content streams are substantially dissimilar with respect to one another.

6. The method according to claim 1, wherein the first and second content streams, and the corresponding turning points, are substantially similar with respect to one another.

7. The method according to claim 6, wherein the playing of the first and second content streams is respectively observed by at least first and second individuals.

8. The method according to claim 7, wherein the first and second individuals are each located within a space defined in the real world.

9. The method according to claim 7, wherein the first and second individuals are each represented by an avatar located within a space defined in a virtual world.

10. The method according to claim 7, wherein the detection of the asynchronicity of the first and second content streams comprises:
timekeeping with respect to each of the first and second content streams and each of the first and second individuals; and
detecting that one of the first and second content streams leads and/or lags the other content stream.

11. The method according to claim 10, wherein the detection of the asynchronicity of the first and second content streams further comprises receiving interest data indicating that at least one of the first and second individuals has an interest in at least the other individual.

12. The method according to claim 11, further comprising activating the selective synchronization in accordance with the timekeeping, the lead and/or lag detection and the reception of the interest data.

13. The method according to claim 12, further comprising alerting at least the one of the first and second individuals having the interest in at least the other individual that the selective synchronization is complete.

14. The method according to claim 13, further comprising secondarily alerting at least the one of the first and second individuals having the interest in at least the other individual that the first and second content streams are asynchronous.

15. A computer readable medium having instructions stored thereon to execute the method according to claim 14.

16. A method of operating content streams, comprising:
detecting that first and second content streams are asynchronously provided to first and second individuals, each of the first and second content streams respectively including first and second turning points;
where at least one of the first and second individuals has an interest in the other, selectively synchronizing at least the first and second turning points of the first and second content streams by inserting gap fillers into at least one of the first and second content streams; and
temporarily alerting at least the interested individual that the first and second turning points are synchronized.

17. A method of operating asynchronous receptions of a broadcast including a turning point, the method comprising:
detecting that an object, from which the broadcast is output, is within a point of view of first and second receivers;
detecting that the broadcast is asynchronously received by the first and second receivers; and
selectively synchronizing the reception of the broadcast by the first and second receivers by inserting gap fillers into the broadcast as received by a leading one of the receivers such that the broadcast is synchronously received by the first and second receivers upon an instance of the turning point.

18. A system configured to operate content streams, the system comprising:
a detecting unit configured to detect that first and second content streams are asynchronously provided to first and second individuals, each of the first and second content streams respectively including first and second turning points;
a receiving unit configured to receive interest data indicating that at least one of the first and second individuals has an interest in the other; and
a synchronizing unit configured to selectively synchronize at least the first and second turning points of the first and second content streams by inserting gap fillers into at least one of the first and second content streams.

19. The system according to claim 18, further comprising a counter configured to keep a time of each of the first and second content streams and each of the first and second individuals.

20. The system according to claim 18, further comprising an alerting unit configured to temporarily alert at least the interested individual that the first and second turning points are synchronized.

21. This system according to claim 20, wherein the alerting unit is further configured to alert at least the one of the first and second individuals having the interest in at least the other individual that the first and second content streams are asynchronous.
